(19) United States
(12) Patent Application Publication
(10) Pub. No.: US 2007/0042930 A1
(43) Pub. Date: Feb. 22, 2007

(54) Effect of beta-glucan on stem cell recruitment and tissue repair

(76) Inventors: Gordon D. Ross, Prospect, KY (US); Trunetta Jo Dockter Ross, Prospect, KY (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/568,261

(22) PCT Filed: Aug. 13, 2004
(86) PCT No.: PCT/US04/26359

§ 371 Date: Nov. 1, 2006

Related U.S. Application Data
(60) Provisional application No. 60/403,424, filed on Aug. 13, 2002.

(51) Int. Cl. C11D 17/00

(52) U.S. Cl. 510/446

(57) ABSTRACT

The invention relates to methods for treating tissue injury and/or afflictions, by administering a prophylactically or therapeutically effective amount of particulate, bioavailable β(1-3;1-6) glucan. The invention also relates to methods in which β(1-3;1-6) glucan is provided in the form of whole glucan particles, microparticulate β-glucan particles or a combination thereof. The invention also relates to method of enhancing glucan-mediated committed stem cell proliferation and expansion after injury via the complement system.

### RELATED APPLICATION

This application claims the benefit of U.S. Provisional Application No. 60/494,772, filed on Aug. 13, 2003. The entire teachings of the above application are incorporated herein by reference.

### GOVERNMENT SUPPORT

The invention was supported, in whole or in part, by grant CA84612 from the National Institutes of Health and by grant DAMD17-02-0445 from the U.S. Army. The Government has certain rights in the invention.

### BACKGROUND OF THE INVENTION

Beta (β)-glucan is a complex carbohydrate, generally derived from several sources, including yeast, bacteria, fungi and cereal grains. Each type of β-glucan has a unique structure in which glucose is linked together in different ways, resulting in different physical and chemical properties. For example, β(1-3) glucan derived from bacterial and algae is linear, making it useful as a food thickener. The frequency of side chains, known as the degree of substitution or branching frequency, regulated secondary structure and solubility. Beta glucan derived from yeast is branched with β(1-3) and β(1-6) linkages that enhances its ability to bind to and stimulate macrophages. β(1-3;1-6) glucan purified from baker's yeast (Saccharomyces cerevisiae) is a potent anti-infective beta-glucan immunomodulator.

The cell wall of S. cerevisiae is mainly composed of β-glucans, which are responsible for its shape and mechanical strength. While best known for its use as a food grade organism, yeast is also used as a source of zymosan, a crude insoluble extract used to stimulate a non-specific immune response. Yeast-derived beta (1-3) glucans stimulate the immune system, in part, by activating the innate anti-fungal immune mechanisms to fight a variety of targets. Baker's yeast β(1-3;1-6) glucan is a polysaccharide composed entirely of β(1-3)-linked glucose molecules forming the polysaccharide backbone with periodic β(1-3) branches linked via β(1-6) linkages). It is more formally known as poly-(1-6)-β-D-glucopyranosyl-(1-3)-β-D-glucopyranose. Glucans are structurally and functionally different depending on source and isolation methods.

Beta glucans possess a diverse range of activities. The ability of β-glucan to increase nonspecific immunity and resistance to infection is similar to that of endotoxin. Early studies on the effects of β(1-3) glucan on the immune system focused on mice. Subsequent studies demonstrated that β(1-3) glucan has strong immunostimulating activity in a wide variety of other species, including earthworms, shrimp, fish, chicken, rats, rabbits, guinea pigs, sheep, pigs cattle and humans. Based on these studies, β(1-3) glucan represents a type of immunostimulant that is active across the evolutionary spectrum, likely representing an evolutionarily innate immune response directed against fungal pathogens. However, despite extensive investigation, no consensus has been achieved on the source, size, and form of β(1-3) glucan ideal for use as an immunostimulant.

The use of β(1-3; 1-6) glucans as hematopoietic agents has been tentatively explored in several references. For example, U.S. Pat. No. 5,532,223 by Jamas et al. demonstrates the use of parenteral neutral soluble glucan to stimulate hematopoietic and immunological effects without stimulating the production of undesired cytokines. Patchen and colleagues demonstrated that parenterally administered soluble and particulate beta-glucans can enhance hematopoietic recovery and the ability to resist infection in mice exposed to radiation when administered either before or after exposure to radiation. See M. L. Patchen et al., “lucan: mechanisms involved in its ‘radioprotective’ effect”, J. Leukoc. Biol., 42, 95(1987). Beta glucan has also been used as a topical antioxidant to protect the skin from damage caused by ultraviolet radiation. See J. A. Greene, “Composition for protecting skin from damaging effects of ultraviolet light”, U.S. Pat. No. 6,235,272. Oral β glucans are also shown to be a radiaprotectant as described in PCT/US03/25237 (Attorney Docket No. 2732.1048-003), the entire contents is incorporated by reference. A need exists for a formulation of β-glucan, particularly an oral formulation, which can be readily stored and administered to humans for enhancing tissue repair resulting from injury.

### SUMMARY OF THE INVENTION

The invention relates to methods of treating or preventing the reduction of committed stem cell activity created by injury by administering a prophylactically or therapeutically effective amount of particulate, bioavailable β(1,3;1,6) glucan. In another embodiment, the invention relates to the use of a particulate bioavailable β(1,3; 1,6) glucan for the manufacture of a medicament for oral use in treating myelosuppression following injury, such as radiation, wherein the orally administered glucan enhances proliferation, activation and differentiation of committed stem progenitor cells by functioning with the complement system by providing a second signal for CR3 activation. The committed stem cells can be progenitor cells for various organs or tissues such as cardiac stem cells, hepatic stem cells, kidney stem cells, neuronal stem cells, muscle stem cells as well as other stem cells.

Also described herein are methods of enhancing glucan-mediated committed progenitor stem cell recovery after exposure to injury, such as radiation, via the complement system pathway, comprising administering to an individual a therapeutically effective orally bioavailable amount of whole glucan particles, wherein the glucan enhances regeneration or proliferation of progenitor stem cells. The β(1,3; 1,6) glucan functions with complement activation after injury to promote stem cell attachment to the injury site via stem cell CR3 binding to iC3b stem cells that are attached via iC3b by providing the “second signal” for CR3 activation. This ligation of glucan to the lectin domain of CR3 is more efficient than the natural lectin site signal mediated by damaged tissue heparin sulphate. In certain embodiments of the methods of the invention, the orally administered glucan is transported to the bone marrow and degraded. At the bone marrow, the degraded oral glucan activates stem cells via the complement system pathway by binding to iC3b deposited on injured stem cell and activating CR3. That is, the invention pertains to a method of enhancing glucan-mediated progenitor stem cell proliferation and expansion, after injury, such as by the exposure to radiation or any other damaging agent or event, via the complement system pathway, comprising administering to an individual a therapeutically effective orally bioavailable amount of whole glucan particles, wherein the glucan via the complement system pathway enhances regeneration of hematopoietic progenitor stem cells and proliferation of committed stem cells. The orally administered glucan is taken up by macrophages, degraded and transported to the committed stem cells. At the committed stem cells, the glucan activates the complement system pathway from binding to iC3b deposited on a committed stem cell and providing the second signal by priming CR3 of stem cell thereby activating the stems cell to differentiate and proliferate. In certain embodiments, the committed stem cells are selected from the group consisting of committed stem cells from the liver, heart, muscle, kidney and neural tissue.

In another embodiment, the invention relates to a method of enhancing tissue repair via committed stem cell recruitment, comprising administering to an individual with an injury a bioavailable amount of whole glucan particles, wherein the glucan activates stem cells via the complement system pathway and enhances the stem cell recruitment to the site of injury. The whole glucan particle via the complement system promotes stem cell proliferation and differentiation by binding to iC3b deposited on injured stem cells and activating CR3.

Also described herein, is a method of enhancing glucan-mediated committed progenitor stem cell recovery after injury via the complement system pathway, comprising administering to an individual a therapeutically effective orally bioavailable amount of whole glucan particles, wherein the glucan binds and activates the complement system pathway and wherein enhancement of committed progenitor stem cells are regenerated and proliferated. The orally administered whole glucan particle is taken up by macrophages, transported to the bone marrow, degraded and fragments released that prime the CR3 of stem cells activating the stem cells to differentiate and proliferate. Via the complement system pathway, the whole glucan particle promotes stem cell proliferation and differentiation by binding to iC3b deposited on injured stem cells and priming CR3.

In another embodiment, a method of treating injury by delivering an agent and whole glucan particles to the site of injury is described. The method enhances committed stem cell proliferation by administering to an individual with an injury, an agent and whole glucan particles. The whole glucan particles enhance glucan-mediated committed stem proliferation and the agent enhances injury recovery. The agent can be a drug that produces a pharmacologic response at the site of injury. Suitable agents include, but are not limited to, proteins, peptides, hormones, vaccines, antiallergens, steroids, cardioactive agents, nucleic acids, and growth factors.

### BRIEF DESCRIPTION OF THE DRAWINGS

FIG. 1 is a graphic depiction of oral P-glucan particles stimulate an enhanced recovery of white blood cells following irradiation.

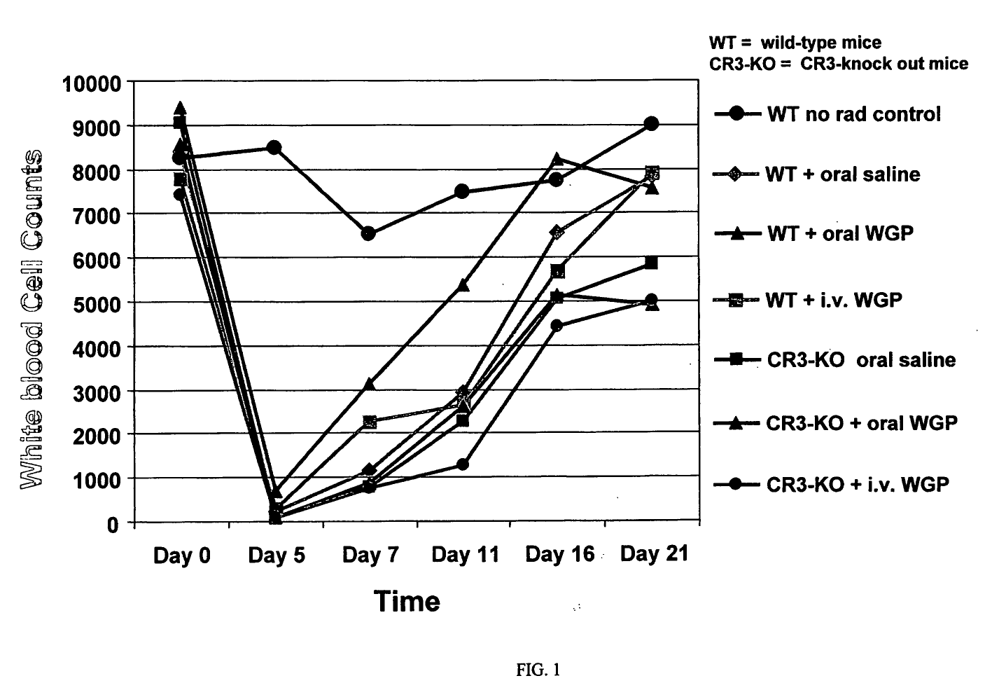

FIG. 2 is a graphic depiction of statistical analysis of oral β-glucan effect on white blood cell count recovery after irradiation.

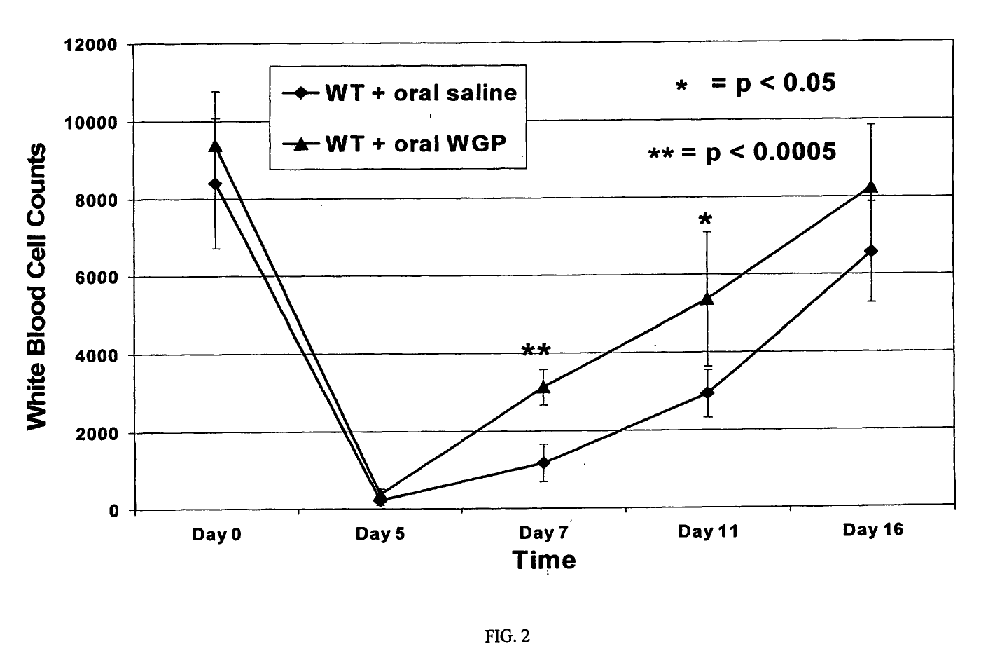

FIG. 3 is a graphic depiction showing CR3 requirement for oral β-glucan-mediated white blood cell recovery after irradiation.

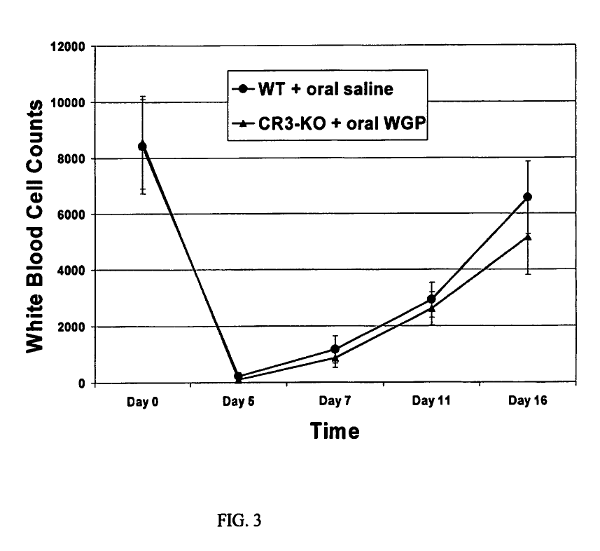

FIG. 4 is a schematic drawing showing radiation injury exposes a neo-epitope for an IgM natural antibody that binds to stromal epithelium and activates complement.

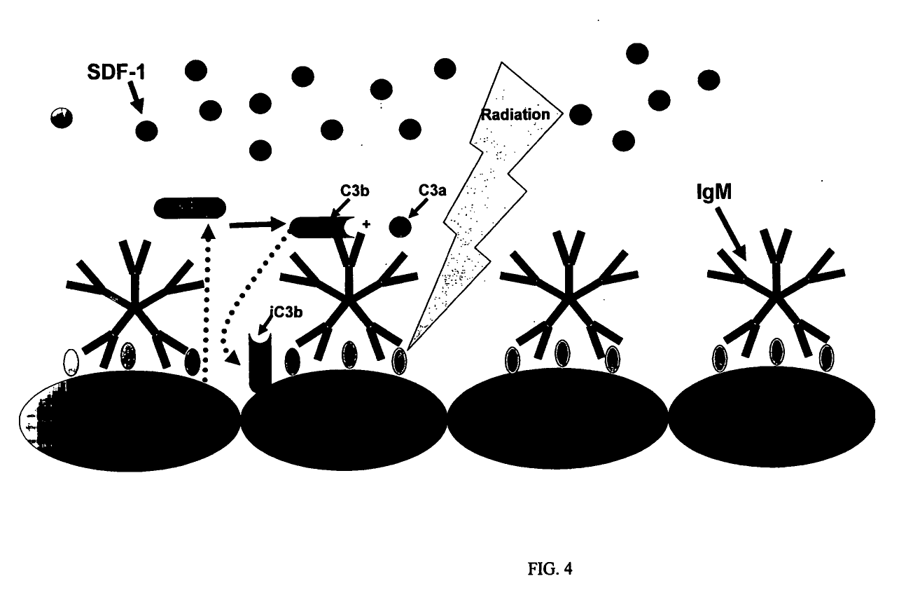

FIG. 5 is a schematic drawing showing C3a-C3aR stimulation potentiates CXCR4 Signaling to be sensitive to small amounts of SDF-1 and recruitment to the site of injury.

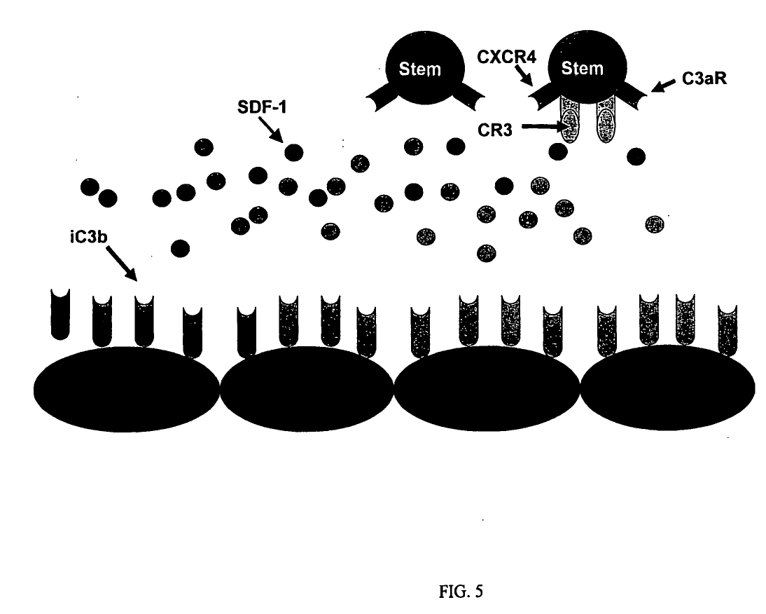

FIG. 6 is a schematic drawing showing recruited stem cells bind via CR3 to iC3b-tagged stromal cells; heparan sulfate binds to the lectin domain of CR3 and stimulates proliferation.

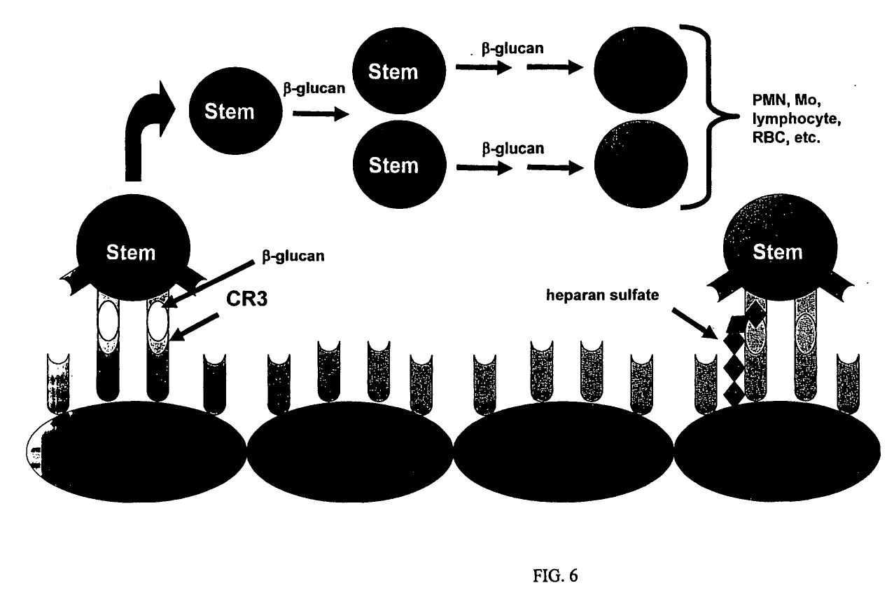

FIG. 7 is a graphic depiction showing whole body irradiation induces complement activation in the bone marrow with C3 deposition on marrow cells.

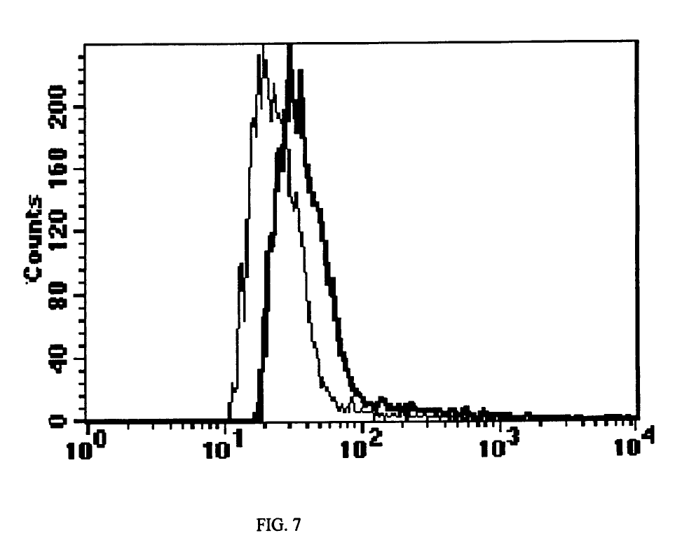

FIG. 8A and 8B are graphic depictions showing G-CSF mobilization stimulates complement activation in bone marrow with iC3b deposition on stromal cells.

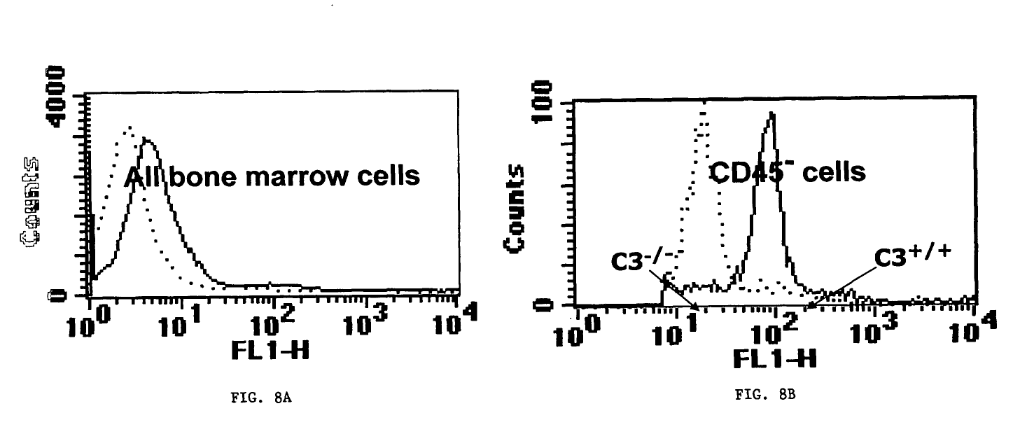

FIG. 9A through 9F are graphic depictions showing G-CSF stimulated mobilization does not activate complement in the bone marrow of immunoglobulin-deficient SCID mice.

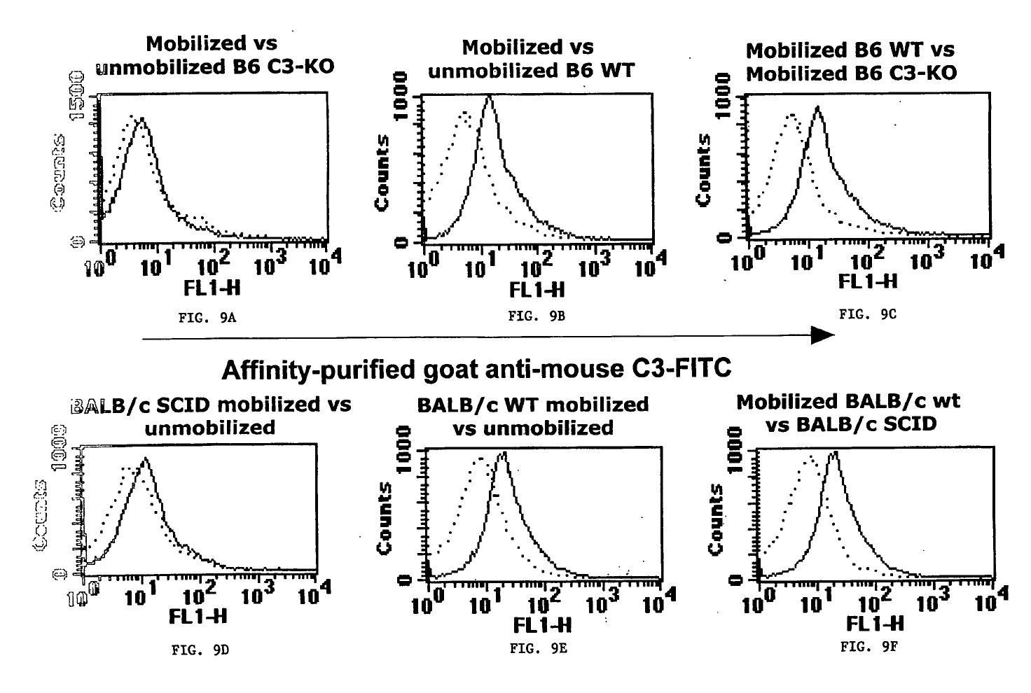

### DETAILED DESCRIPTION OF THE INVENTION

A description of preferred embodiments of the invention follows.

The present invention relates to methods of using an oral, bioavailable p(1-3;1-6) glucan as a pharmaceutical or dietary agent for tissue repair or other injuries and/or afflictions. Moreover, the present invention relates to methods of using β(1-3;1-6) glucan in whole glucan particle form and/or microparticulate β-glucan particle form as a pharmaceutical agent for the treatment of injured tissues and for the recruitment committed stem cells. Additionally, the present invention relates to the use of β(1-3;1-6) glucan in whole glucan particle form, microparticulate β-glucan particle form or any combination thereof as a stem cell recruiter via the complement pathway.

Whole glucan particle (WGP) is a highly purified, yeast cell wall preparation, with a preferred particle size of one micron or greater. In some embodiments, the particle size is less than one micron. The preparation and use of these compounds for the prevention and treatment of suppressed stem cell is described below.

Various forms of particulate and soluble β-glucans have been prepared. One example is microparticulate glucan particles, which can be formed by finely grinding yeast cell wall β(1-3; 1-6) glucan down to a particle size of about one micron or less. Beta glucan in this form has been applied to use as a nutritional supplement and skin restorer, such as disclosed in U.S. Pat. No. 5,702,719, by Donzis.

Microparticulate β3-glucan particles have also been shown to enhance the host's immune system. See U.S. Pat. Nos. 5,223,491 and 5,576,015, the teachings of which are incorporated herein by reference in their entirety. Another form of β-glucan is neutral soluble β-glucans, which are prepared through a series of acid, alkaline and neutral treatment steps to yield a conformationally pure neutral soluble glucan preparation. The neutral soluble glucan preparation enhances a host's immune system but does not induce the production of IL-1 and TNF and thus does not cause inflammation. See U.S. Pat. No. 5,783,569, the teachings of which are incorporated herein by reference in its entirety.

Another form of β-glucan is an insoluble particle known as whole glucan particles (WGP). Whole glucan particles are the remnants of the yeast cell wall prepared by separating growing yeast from its growth medium and subjecting the intact cell walls of the yeast to alkali, thus removing unwanted proteins and nucleic acid material. In certain embodiments, what remains is a spherical beta-glucan particle with the outer mannan protein removed. Whole glucan particles may be obtained from any glucan-containing fungal cell wall source, but the preferred source is a strain of S. cerevisiae. These insoluble particles have been shown to enhance host resistance to a wide range of infections, increase antibody production (adjuvant activity), increase leukocyte mobilization, and enhance wound healing. Methods of producing WGP are known in the art and are disclosed in U.S. Pat. Nos. 4,810,646, 4,4992,540, 5,037,972, 5,082,936, 5,250,436, and 5,506,124, the contents of which are incorporated herein by reference in their entirety. WGP can be further broken down into various components, each with differing affinities for binding to subsets of receptors found on innate immune cells. These various confornational forms are, in increasing order of complexity, random coil, single helix, triple helix, and triple helical multimer. WGP has shown a variety of biological activities, including use as a vaccine adjuvant (U.S. Pat. No. 5,741,495), an anti-infective agent (Pedroso M., “Application of beta-1,3-glucan to prevent shipping fever in imported heifers,” Arch. Med. Res. 25(2), 181 (1994)), and an antitumor agent (Borchers, A. T., et al., Proc. Soc. Exp. Biol. Med, 221(4), 281 (1999)). Each conformational form possess different activities as is demonstrated by the different specificities observed for glucan receptors.

The β-glucans for use in the methods described herein are oral bioavailable formulations. Bioavailable as used herein means the whole glucan particle is able to reach the target of action. The whole glucan particle has enough β(1-3; 1-6) glucan exposed for Peyer's patch uptake of the glucan. The glucan is taken up in the Peyer's patch and engulfed and degraded by macrophages, transported to the bone marrow where the degraded fragments are released. The degraded fragments activate the complement system by binding to iC3b deposited on injured stem cell and activate CR3. For example, the WGP is able to reach and act on the bone marrow or other stem cell. At the site of action, the glucan acts to stimulate stem cells as a result of the binding or association of the glucan to the CR3 receptor that in turn primes or promotes the CR3 for action. The bioavailability of oral WGP is mediated by the transport of WGP to the bone marrow by gastrointestinal macrophages that degrade the particle. The degraded particles then function at the bone marrow as stimulators of stem cell CR3 activation.

Tissue Injury

The CR3/glucan receptor is present on a wide variety of committed stem cell progenitors as well as hematopoietic stems cells. This indicates that glucan mediated complement activation can enhance and promote stem cell repair of many types of tissue injuries.

Cardiac

Cardiac stem cells express CR3 and that cardiac tissue following a heart attack is a site of complement deposition and cardiac stem cell recruitment. Therefore, glucan mediated complement activation can enhance the repair of heat damage following a hear attack.

Tissue Injury and Use of Beta Glucan

β-glucans have the ability to stimulate stem cell proliferation, differentiation and activation via complement activation. β-glucan, a well-known biological response modifier (BRM), stimulates hematopoiesis (blood cell formation), in an analogous manner as granulocyte monocyte-colony stimulating factor (GM-CSF). Research was carried out initially with particulate β-glucan and later with soluble β-glucans, all of which were administered intravenously to mice (Patchen M. L., et al.,J. Biol. Response Mod 3:627-633 (1984), Patchen, M. L., et al., Experientia 40:1240-1244 (1984), Petruczenko, A. Acta. Physiol. Pol. 35:231-236 (1984) and Patchen, M. L. and T. J. MacVittie., Int. J Immunopharmacol. 7:923-932 (1985)). Mice exposed to 500-900 cGy of gamma radiation exhibited a significantly enhanced recovery of blood leukocyte, platelet and red blood cell counts when given i.v. β-glucans ( Patchen, M. L. and T. J. MacVittie. J. Biol. Response Mod 5:45-60 1986) and Patchen, M. L., et al., Methods Find. Exp. Clin. Pharmacol. 8:151-155 (1986)). Other reports showed that β-glucan could reverse the myelosuppression produced with chemotherapeutic drugs such as fluorouracil (Matsuo, T., et al., Jpn. J. Cancer Chemother. 14:1310-1314 (1987) or cyclophosphamide (Wagnerová, J., et al., Immunopharmacol. Immunotoxicol. 15:227-242 (1993) and Patchen, M. L et al., Exp. Hematol. 26:1247-1254 (1998)). Moreover, the anti-infective activity of β-glucan combined with its hematopoiesis-stimulating activity resulted in enhanced survival of mice receiving a lethal dose of 900-1200 cGy of radiation. In vitro studies showed that β-glucan could enhance granulocyte and megakaryocyte colony formation by hematopoietic stem progenitor cells when used in combination with GM-CSF and interleukin-3 (IL-3), respectively ( Turnbull, J. L et al., Acta Haematol. 102:66-71 (1999)). Development of β-glucans for their hematopoietic activity was not considered worthwhile at that time because of advent of GM-CSF as a therapeutic agent.

With many types of tissue damage, complement has been shown to be activated but the reason for activation is unclear. It was shown in the 1980's to be associated with heart attacks, i.e., C3 was found to be deposited on the injury myocardium. This observation was reproduced later in animals and with other types of muscle tissue damage. With skeletal and smooth muscle, it was demonstrated that the damaged tissue reacted with a natural IgM antibody, resulting in activation of the classical pathway of complement. As described herein, current work with the bone marrow injury caused by radiation, chemotherapy, or G-CSF-mediated stem cell mobilization (used for bone marrow transplantation) seems to be indicating that IgM natural antibody is similarly involved in activating complement on the damaged bone marrow stromal cells. This was shown by demonstrating that complement activation in bone marrow did not occur in IgM-deficient (SCID) mice. Complement activation in bone marrow occurs in SCID mice that have been injected with (reconstituted with) the IgM from normal mice. Cloning the B cell that makes the critical IgM antibody responsible for complement activation in skeletal muscle injury can also be done to show that activating complement in bone marrow monoclonal IgM will promote complement activation in damaged skeletal or smooth muscles of SCID mice.

An early signal of tissue damage starts the process of tissue repair by recruiting committed stem cells data showing that neuronal (nerve), liver, and kidney stem cells all express CR3 is described here. The data show that the CR3 of stem cells is used by the cells to attach to the site of injury by way of the iC3b that is deposited there. Damaged tissue also expresses a polysaccharide that binds to CR3 somewhat like beta-glucan, i.e., heparan sulfate. Others have shown that hematopoietic stem cells can use their CR3 to attach to surfaces coated with heparan sulfate. This results in dual ligation of CR3 to both iC3b and heparan sulfate, and that this triggers rapid stem cell division and differentiation. Soluble beta-glucan functions as a more efficient second signal than heparan sulfate for CR3 activation on stem cells. That is, stem cells only need to become tethered to the iC3b on damaged tissue and not to heparan sulfate if there is beta-glucan available to replace the heparan sulfate. This mechanism for stem cell activation by bound iC3b plus soluble beta-glucan is very analogous to the mechanism used to activate CR3 on neutrophils for killing tumors coated with iC3b.

Subsequently, as described herein, the oral immunomodulatory activities of β-glucans have been recognized. It is believed that the oral uptake of certain β-glucans by M (microfold) cells in intestinal Peyer's patches leads to β-glucan presentation to macrophages in the underlying gut-associated lymphatic tissue (GALT). Orally delivered mushroom β-glucans have been shown to activate peritoneal and alveolar macrophages. Further, oral administration of the shitake mushroom-derived β-glucan, lentinan has been found to increase the number of T helper cells in blood of rats. Oral β-glucan has also been shown to induce anti-infective (Hotta, H., K. et al., Int. J Immunopharmacol. 15:55-60 (1993) and Vetvicka, V., K. J. Amer. Nutrit. Assoc. 5:1-5 (2002)) and anti-tumor activities in both preclinical and clinical studies (Nanba, H., K. et al., Chem. Pharm. Bull. (Tokyo)35:2453-2458 (1987); Suzuki, I., T. et al., Chem. Pharm. Bull. (Tokyo) 39:1606-1608 (1991) and Toi, M., T. et al., Cancer 70:2475-2483 (1992)). Summarizing available data, β-glucans function by stimulating host immune defense mechanisms, primarily macrophages, neutrophils, NK cells, and dendritic cells, thereby enhancing microbial or tumor cell clearance and subsequently reducing mortality (Onderdonk, A., et al., Infect. Immun. 60:1642-1647 (1992) and Kaiser, A. B. and D. S. Kernodle, Antimicrob. Agents Chemother. 42:2449-2451 (1998)).

Yeast-derived β(1-3; 1-6) glucans work, in part, by stimulating innate anti-fungal immune mechanisms to fight a range of pathogenic challenges from bacteria, fungi, parasites, viruses, and cancer. Research to define the mechanism of action of β-glucans has shown that they function through the priming of macrophages, neutrophils, monocytes, and NK cells, giving these cells an enhanced activity to kill microbial pathogens or tumor cells. Beta glucans from various sources with different structures have been shown to bind to a variety of receptors. Mannans, galactans, a (1,4)-linked glucose polymers and β(1,4)-linked glucose polymers have no avidity for the receptor located on leukocytes. Two β-glucan-binding receptors on leukocytes have been characterized that function to promote the phagocytosis of yeast cells walls via binding to β-glucan. First, the iC3b-receptor CR3 (also known as Mac-1, CD11b/CD18, or α_{M}β₂-integrin) was shown to have a β-glucan-binding lectin site that functioned in the phagocytosis of yeast cell walls by neutrophils, monocytes, and macrophages (Ross, G. D., et al., Complement Inflamm. 4:61-74 (1987) and Xia, Y., V. et al., J. Immunol. 162:2281-2290 (1999)). Mac-1/CR3 functions as both an adhesion molecule mediating the diapedesis of leukocytes across the endothelium and a receptor for the iC3b fragment of complement responsible for phagocytic/degranulation responses to microorganisms. Mac-1/CR3 has many functional characteristics shared with other integrins, including bidirectional signaling via conformational changes that originate in either the cytoplasmic domain or extracellular region. Another key to its functions is its ability to form membrane complexes with glycosylphosphatidylinositol (GPI)-anchored receptors such as Fc gammaRIIIB (CD16b) or uPAR (CD87), providing a transmembrane signaling mechanism for these outer membrane bound receptors that allows them to mediate cytoskeleton-dependent adhesion or phagocytosis and degranulation. Many functions appear to depend upon a membrane-proximal lectin site responsible for recognition of either microbial surface polysaccharides or GPI-linked signaling partners. Because of the importance of Mac-1/CR3 in promoting neutrophil inflammatory responses, therapeutic strategies to antagonize its functions have shown promise in treating both autoimmune diseases and ischemia/reperfusion injury. Conversely, soluble beta-glucan polysaccharides that bind to its lectin site prime the Mac-1/CR3 of circulating phagocytes and natural killer (NK) cells, permitting cytotoxic degranulation in response to iC3b-opsonized tumor cells that otherwise escape from this mechanism of cell-mediated cytotoxicity. CR3 binds soluble fungal β-glucan with high affinity (5×10⁻⁸ M) and this primes the receptor of phagocytes or NK cells for cytotoxic degranulation in response to iC3b-coated tumor cells. The tumoricidal response promoted by soluble β-glucan in mice was shown to be absent in mice deficient in either serum C3 (complement 3) or leukocyte CR3, highlighting the requirement for iC3b on tumors and CR3 on leukocytes in the tumoricidal function of β-glucans Vetvicka, V., et al., J. Clin. Invest. 98:50-61 (1996) and Yan, J., V. et al., J. Immunol. 163:3045-3052 (1999)).

Dectin-1 represents the second membrane receptor for β-glucan involved with glucan particle phagocytosis . Dectin-1 is expressed at high levels on thioglycolate-elicited peritoneal macrophages and its activity predominates over that of CR3 in the phagocytosis of yeast via p-glucan binding by these activated cells. However, yeast phagocytosis by neutrophils and resident peritoneal macrophages is blocked by anti-CR3 and does not occur with CR3-deficient (CD11b⁻¹) neutrophils or resident macrophages. Moreover, dectin-1 is not expressed by NK cells that use CR3 to mediate tumoricidal activity against iC3b-opsonized mammary carcinoma cells following priming with β-glucan. Thus the role of dectin-1 in mediating β-glucan activities appears to be limited to activated peritoneal macrophages and perhaps also the intestinal CR3 ^{-/-} macrophages observed to contain WGP-DTAF in this investigation.

The apparent need to administer β-glucans intravenously makes it unfeasible to consider use as a treatment for large numbers of people in emergency situations. Surprisingly, as described herein, orally administered whole glucan particles function to accelerate hematopoiesis following irradiation in an analogous manner as i.v. administered β-glucan, there is renewed interest in determining the mechanism and potential usefulness of β-glucan as a radioprotective drug for these types of nuclear emergencies.

The oral anti-infective and radiochemoprotective activities of a wide range of mushroom and yeast-derived β-glucans have been widely reported. As discussed above, the oral uptake of these high molecular weight β-glucans has been proposed via M cells in intestinal Peyer's patches. The results presented herein extend these observations to demonstrate that the oral uptake of yeast WGP Beta Glucan particles leads to β-glucan presentation to macrophages in the underlying GALT. These WGP Beta Glucan-containing cells then transport the WGP Beta Glucan into the organs of the reticuloendothelial system (lymph nodes, spleen and BM). This oral uptake and systemic distribution of WGP appears to be independent of the CR3-mediated mechanism of yeast particle phagocytosis, as there was the same uptake and distribution of WGP-DTAF in both wild-type and CR3^{31 /-} animals. The dectin-1 receptor, or other receptor can be responsible for this oral uptake of WGP Beta Glucan into the GALT.

Preparation of WGP Glucan

In certain embodiments, the preparation of WGP glucan is briefly, the process for producing the glucan particles involves the extraction and purification of the alkali-insoluble whole glucan particles from the yeast or fungal cell walls. This process yields a product, which maintains the morphological and structural properties of the glucan as, found in vivo, as is referred to as a whole glucan, or whole glucan particles.

The structure-function properties of the whole glucan preparation depend directly on the source from which it is obtained and also from the purity of the final product. The source of whole glucan can be yeast or other fungi, or any other source containing glucan having the properties described herein. In certain embodiments, yeast cells are a preferred source of glucans. The yeast strains employed in the present process can be any strain of yeast, including, for example, S. cerevisiae, S. delbrueckii, S. rosei, S. microellipsodes, S. carlsbergensis, S. bisporus, S. fermentati, S. rouxii, Schizosaccharomyces pombe, Kluyveromyces polysporus, Candida albicans, C. cloacae, C. tropicalis, C. utilis, Hansenula wingei, H. arni, H. henricii H. americana, H. canadiensis, H. capsulata, H. polymorpha, Pichia kluyveri, P. pastoris, P. polymorpha, P. rhodanensis, P ohmeri, Torulopsis bovin, and T. glabrata.

Generally, the above procedure can be used to prepare and isolate other mutant yeast strains with other parent strains as starting material. Additionally, mutagens can be employed to induce the mutations, for example, chemical 30 mutagens, irradiation, or other DNA and recombinant manipulations. Other selection or screening techniques may be similarly employed.

The yeast cells may be produced by methods known in the art. Typical growth media comprise, for example, glucose, peptone and yeast extract. The yeast cells may be harvested and separated from the growth medium by methods typically applied to separate the biomass from the liquid medium. Such methods typically employ a solid-liquid separation process such as filtration or centrifugation. In the present process, the cells are preferably harvested in the mid-to late logarithmic phase of growth, to minimize the amount of glycogen and chitin in the yeast cells. Glycogen, chitin and protein are undesirable contaminants that affect the biological and hydrodynamic properties of the whole glucan particles.

Preparation of whole glucan particles involves treating the yeast with an aqueous alkaline solution at a suitable concentration to solubilize a portion of the yeast and form an alkali-hydroxide insoluble whole glucan particles having primarily β(1-6) and β(1-3) linkages. The alkali generally employed is an alkali-metal hydroxide, such as sodium or potassium hydroxide or an equivalent. The starting material can comprise yeast separated from the growth medium. It is more difficult to control consumption of the aqueous hydroxide reactants and the concentration of reactants in the preferred ranges when starting with yeast compositions that are less concentrated. The yeast should have intact, unruptured cell walls since the preferred properties of the instant whole glucan particles depend upon an intact cell wall.

The treating step is performed by extracting the yeast in the aqueous hydroxide solution. The intracellular components and mannoprotein portion of the cell are solubilized in the aqueous hydroxide solution, leaving insoluble cell wall material which is substantially devoid of protein and having a substantially unaltered three dimensional matrix of β(1-6) and β(1-3) linked glucan. The preferred conditions of performing this step result in the mannan component of the cell wall being dissolved in the aqueous hydroxide solution. The intracellular constituents are hydrolyzed and released into the soluble phase. The conditions of digestion are such that at least in a major portion of the cells, the three dimensional matrix structure of the cell walls is not destroyed. In particular circumstances, substantially all the cell wall glucan remains unaltered and intact.

In certain embodiments, the aqueous hydroxide digestion step is carried out in a hydroxide solution having initial normality of from about 0.1 to about 10.0. Typical hydroxide solutions include hydroxides of the alkali metal group and alkaline earth metals of the Periodic Table. The preferred aqueous hydroxide solutions are of sodium and potassium, due to their availability. The digestion can be carried out at a temperature of from about 20° C. to about 121° C. with lower temperatures requiring longer digestion times. When sodium hydroxide is used as the aqueous hydroxide, the temperature can be from about 80° C. to about 100° C. and the solution has an initial normality of from about 0.75 to about 1.5. The hydroxide added is in excess of the amount required, thus, no subsequent additions are necessary.

Generally from about 10 to about 500 grams of dry yeast per liter of hydroxide solution is used. In certain embodiments, the aqueous hydroxide digestion step is carried out by a series of contacting steps so that the amount of residual contaminants such as proteins are less than if only one contacting step is utilized. In certain embodiments, it is desirable to remove substantially all of the protein material from the cell. Such removal is carried out to such an extent that less than one percent of the protein remains with the insoluble cell wall glucan particles. An additional extraction step is preferably carried out in a mild acid solution having a pH of from about 2.0 to about 6.0. Typical mild acid solutions include hydrochloric acid, sodium chloride adjusted to the required pH with hydrochloric acid and acetate buffers. Other typical mild acid solutions are in sulfuric acid and acetic acid in a suitable buffer. This extraction step is preferably carried out at a temperature of from about 20° C. to about 100° C. The digested glucan particles can be, if necessary, subjected to further washings and extraction to reduce the protein and contaminant levels.

By conducting this process without a step of disrupting the cell walls, the extraction can be conducted at more severe conditions of pH and temperature than was possible with the prior art procedure that included a step of disrupting the cell walls. That is, the process of this invention avoids product degradation while employing these severe extraction conditions which permits elimination of time-consuming multiple extraction steps.

After the above aqueous hydroxide treatment step, the final whole glucan product comprises about 5 to about 30 percent of the initial weight of the yeast cell, preferably the product is from about 7 to about 15 percent by weight.

The aqueous hydroxide insoluble whole glucan particles produced is as set forth in the summary of the invention. The whole glucan particles can be further processed and/or further purified, as desired. For example, the glucan can be dried to a fine powder (e.g., by drying in an oven); or can be treated with organic solvents (e.g., alcohols, ether, acetone, methyl ethyl ketone, chloroform) to remove any traces or organic-soluble material, or retreated with hydroxide solution, to remove additional proteins or other impurities that may be present.

In certain embodiments, the whole glucan particles obtained from the present process are comprised of pure glucan, which consists essentially of β(1-6) and β(1-3) linked glucan. The whole glucan particles contain very little contamination from protein and glycogen. In certain embodiments, the whole glucan particles are spherical in shape with a diameter of about 2 to about 10 microns and contain greater than about 85% by weight hexose sugars, or in other embodiments greater than 60% hexose sugars, approximately 1% by weight protein and no detectable amount of mannan, as determined monosaccharide analysis. Glucans obtained by prior processes contain substantially higher quantities of chitin and glycogen than the present glucans.

The second step as set forth above, involves the modification of the whole glucan particles, as produced above, by chemical treatment to change the properties of the glucan. It is contemplated that whole glucan particles derived from any yeast strain may be used, in addition to those particular strains described herein. As mentioned above, a very broad spectrum of yeast or mutant yeast strains may be used. The processing conditions described above are also applicable to glucan extraction from fungi in general. The properties of these glucans also will depend on the sources from which they are derived.

According to a first chemical treatment, the whole glucan particles can be treated with an acid to decrease the amount of β(1-6) linkages and thus, change the hydrodynamic properties of said glucans as evidenced by an increase in the viscosity of aqueous solutions of these modified glucans.

A process for preparing an altered whole glucan particles by treating the glucan particles with an acid, for a suitable period of time to alter the β(1-6) linkages can also be used. Acetic acid is preferred, due to its mild acidity, ease of handling, low toxicity, low cost and availability, but other acids may be used. Generally these acids should be mild enough to limit hydrolysis of the β(1-3) linkages. The treatment is carried out under conditions to substantially only affect the β(1-6) linked glucans. In certain embodiments, the acid treatment is carried out with a liquid consisting essentially of acetic acid, or any dilutions thereof (typical diluents can be organic solvents or inorganic acid solutions). The treatment is carried out at a temperature of from about 20° C. to about 100° C. In certain embodiments, the treatment is carried out to such an extent to remove from about 3 to about 20 percent by weight of acid soluble material based on total weight of the whole glucan particles before treatment. In other embodiments, the extent of removal is from about 3 to about 4 percent by weight. Certain compositions formed demonstrate altered hydrodynamic properties and an enhancement in viscosity after treatment.

According to a second chemical treatment, the whole glucan particles are treated with an enzyme or an acid, to change the amount of β(1-3) linkages. For whole glucan particles derived from some yeast strains, enzyme treatment causes a decrease in the viscosity, and for others, it causes an increase in viscosity, but in general, alters the chemical and hydrodynamic properties of the resulting glucans. The treatment is with a β(1-3) glucanase enzyme, such as laminarinase, for altering the P(1-3) linkages to alter the hydrodynamic properties of the whole glucan particles in aqueous suspensions.

The enzyme treatment can be carried out in an aqueous solution having a concentration of glucan of from about 0.1 to about 10.0 grams per liter. Any hydrolytic glucanase enzyme can be used, such as laminarinase, which is effective and readily available. The time of incubation may vary depending on the concentration of whole glucan particles and glucanase enzyme. The (1-3) linkages are resistant to hydrolysis by mild acids such as acetic acid. Treatment with strong or concentrated acids, such as hydrochloric acid (HCl), sulfuric acid (H₂SO₄) or formic acid, hydrolyzes the β(1-3) linkages thereby reducing the amount of β(1-3) linkages. The acid treatment can be carried out in an aqueous solution having a concentration of glucan from about 0.1 to about 10.0 grams per liter. The time of acid treatment may vary depending upon the concentration of whole glucan particles and acid. Acid hydrolysis can be carried out at a temperature of from about 20° C. to about 100° C. The preferred compositions formed demonstrate altered hydrodynamic properties.

By controlling the incubation time, it is possible to control the chemical and hydrodynamic properties of the resulting product. For example, the product viscosity can be precisely controlled for particular usage, as, for example, with a variety of food products.

A hydrodynamic parameter (K₁) of the final treated product having altered linkages is dependent on the treatment time according to the final formula:
K₁=−0.0021 (time)+0.26
where time is in minutes; and
where time is less than one hour.

The parameter K₁ is directly related (proportional) to the relative viscosity. In the case of aqueous suspensions the relative viscosity is equal to the actual viscosity when the latter is measured in centipoise.

A process for preparing aqueous slurry of a glucan having a predetermined desired viscosity is provided. The slurry comprises glucan at a concentration that is a function of the predetermined desired viscosity according to the following approximate formula:
1/concentration=K₁×(1/log(relative viscosity))+K₂
Where,
K₁=(shape factor)×(hydrodynamic volume); and
K₂=(hydrodynamic volume)/(maximum packing fraction).

The shape factor is an empirically determined value that describes the shape of the glucan matrix in its aqueous environment. The shape factor is a function of the length: width ratio of a particle and can be determined microscopically. The hydrodynamic volume is a measure of the volume a particle occupies when in suspension. This is an important parameter for glucan suspensions in that it indicates the high water holding capacity of glucan matrices. The maximum packing fraction can be described as the highest attainable volume fraction of glucans that can be packed into a unit volume of suspension.

Preparation of microparticulate β-glucan Particles

Beta (1-3) glucan starting material can be isolated from yeast cell walls by conventional methods known by those of ordinary skill in the art. The general method for the production of glucan from yeast involves extraction with alkali followed by extraction with acid (Hassid et al., Journal of the American Chemical Society, 63:295-298, 1941). Improved methods for isolating a purified water insoluble beta (1-3) glucan extract are disclosed in U.S. Pat. No. 5,223,491, which is incorporated herein by reference in its entirety. Methods for preparing microparticulate β-glucan particles are disclosed in U.S. Pat. No. 5,702,719, the disclosure of which is incorporated herein by reference in its entirety. An improved microparticulate glucan product is obtained when the average particle size is preferably about 1.0 microns or less, and more preferably about 0.20 microns or less.

To obtain the desired smaller particle size, the mixture comprising the beta (1-3) glucan product is ground down using a blender, microfluidizer, or ball mill, for example. One grinding or particle size reduction method utilizes a blender having blunt blades, wherein the glucan mixture is blended for a sufficient amount of time, preferably several minutes, to completely grind the particles to the desired size without overheating the mixture. Another grinding method comprises grinding the glucan mixture in a ball mill with 10 mm stainless steel grinding balls. This latter grinding method is particularly preferred when a particle size of about 0.20 microns or less is desired.

Prior to grinding, the glucan mixture is preferably passed through a series of sieves, each successive sieve having a smaller mesh size than the former, with the final mesh size being about 80. The purpose of sieving the mixture is to separate the much larger and more course glucan particles from smaller particles (the pore size of an 80 mesh sieve is about 0.007 inches or 0.178 mm). The separated larger particles are then ground down as described above and re-sieved to a final mesh size of 80. The process of sieving and grinding is repeated until a final mesh size of 80 is obtained. The sieved particles are combined and ground down further, preferably for at least an hour, until the desired particle size is obtained, preferably about 1.0 micron or less, more preferably about 0.20 microns or less. Periodic samples of the fine grind glucan are taken during the grinding process and measured using a micrometer on a microscope.

Formulation

Oral formulations suitable for use in the practice of the present invention include capsules, gels, cachets, tablets, effervescent or non-effervescent powders or tablets, powders or granules; as a solution or suspension in aqueous or non-aqueous liquid; or as an oil-in-water liquid emulsion or a water-in-oil emulsion. The compounds of the present invention may also be presented as a bolus, electuary, or paste.

Generally, formulations are prepared by uniformly mixing the active ingredient with liquid carriers or finely divided solid carriers or both, and then if necessary shaping the product. A pharmaceutical carrier is selected on the basis of the chosen route of administration and standard pharmaceutical practice. Each carrier must be “acceptable” in the sense of being compatible with the other ingredients of the formulation and not injurious to the subject. This carrier can be a solid or liquid and the type is generally chosen based on the type of administration being used. Examples of suitable solid carriers include lactose, sucrose, gelatin, agar and bulk powders. Examples of suitable liquid carriers include water, pharmaceutically acceptable fats and oils, alcohols or other organic solvents, including esters, emulsions, syrups or elixirs, suspensions, solutions and/or suspensions, and solution and or suspensions reconstituted from non-effervescent granules and effervescent preparations reconstituted from effervescent granules.

Such liquid carriers may contain, for example, suitable solvents, preservatives, emulsifying agents, suspending agents, diluents, sweeteners, thickeners, and melting agents. Preferred carriers are edible oils, for example, corn or canola oils.

Polyethylene glycols, e.g., PEG, are also preferred carriers.

The formulations for oral administration may comprise a non-toxic, pharmaceutically acceptable, inert carrier such as lactose, starch, sucrose, glucose, methyl cellulose, magnesium stearate, dicalcium phosphate, calcium sulfate, mannitol, sorbitol, cyclodextrin, cyclodextrin derivatives, or the like.

Capsule or tablets can be easily formulated and can be made easy to swallow or chew. Tablets may contain suitable carriers, binders, lubricants, diluents, disintegrating agents, coloring agents, flavoring agents, flow-inducing agents, or melting agents. A tablet may be made by compression or molding, optionally with one or more additional ingredients. Compressed tables may be prepared by compressing the active ingredient in a free flowing form (e.g., powder, granules) optionally mixed with a binder (e.g., gelatin, hydroxypropylmethylcellulose), lubricant, inert diluent, preservative, disintegrant (e.g., sodium starch glycolate, cross-linked carboxymethyl cellulose) surface-active or dispersing agent. Suitable binders include starch, gelatin, natural sugars such as glucose or beta-lactose, corn sweeteners, natural and synthetic gums such as acacia, tragacanth, or sodium alginate, carboxymethylcellulose, polyethylene glycol, waxes, or the like. Lubricants used in these dosage forms include sodium oleate, sodium stearate, magnesium stearate, sodium benzoate, sodium acetate, sodium chloride, or the like. Disintegrators include, for example, starch, methyl cellulose, agar, bentonite, xanthan gum, or the like. Molded tablets may be made by molding in a suitable machine a mixture of the powdered active ingredient moistened with an inert liquid diluent.

The tablets may optionally be coated or scored and may be formulated so as to provide slow- or controlled-release of the active ingredient. Tablets may also optionally be provided with an enteric coating to provide release in parts of the gut other than the stomach.

Exemplary pharmaceutically acceptable carriers and excipients that may be used to formulate oral dosage forms of the present invention are described in U.S. Pat. No. 3,903,297 to Robert, issued Sep. 2, 1975, incorporated by reference herein in its entirety. Techniques and compositions for making dosage forms useful in the present invention are described in the following references: 7 Modem Pharmaceutics, Chapters 9 and 10 (Banker & Rhodes, Editors, 1979); Lieberman et al., Pharmaceutical Dosage Forms: Tablets (1981); and Ansel, Introduction to Pharmaceutical Dosage Forms 2nd Edition (1976).

Formulations suitable for parenteral administration include aqueous and non-aqueous formulations isotonic with the blood of the intended recipient; and aqueous and non-aqueous sterile suspensions which may include suspending systems designed to target the compound to blood components or one or more organs. The formulations may be presented in unit-dose or multi-dose sealed containers, for example, ampoules or vials. Extemporaneous injections solutions and suspensions may be prepared from sterile powders, granules and tablets of the kind previously described. Parenteral and intravenous forms may also include minerals and other materials to make them compatible with the type of injection or delivery system chosen.

Exemplification

Materials and Methods

Animals.

A colony of CR3-deficient (CD11b^{-/-}) mice and their wild-type littermates on a C57BL/6 background was established at the University of Louisville from breeders provided by Dr. Tanya Mayadas (Harvard Medical School, Boston, Mass,) who had generated the founder mice Coxon, A., et al.,. Immunity 5:653-666 (1996)). Another colony of mice deficient in the serum complement protein C3 (C3^{-/-}) and their wild-type littermates on a C57BL/6 background was established from heterozygous breeders obtained from the Jackson Laboratory (Bar Harbor, Me.) that came originally from founder mice generated by Dr. Michael Carroll (Center for Blood Research, Harvard Medical School, Boston, Mass.) (Wessels, M. R. et al., Proc. Natl. Acad. Sci. USA 92:11490-11494 (1995)). Mice used for these experiments were all 10 weeks of age, and equal numbers of males and females were examined.

Immune Modulators

Whole glucan particles (WGP, Imucell™ WGP Glucan, Biopolymer Engineering Inc., Eagan, Minn., USA) is a component from the cell walls of Baker's yeast that is purified by extraction of cellular proteins, nucleic acids, lipids, and most non-glucose-based oligosaccharides (e.g., chitin and mannans) by a morphologically non-destructive proprietary process as described by U.S. Pat. No. 5,504,079. It is a highly purified, 3-5 micron, spherical β-glucan particle. Whole glucan particles was labeled with fluorescein using DTAF (Molecular Probes, Inc., Oregon) generating a green WGP-DTAF particle for fluorescence microscopy or flow cytometry.

WGP Absorption and Distribution

Using WGP-DTAF, phagocytosis was measured by flow cytometry and cells isolated with ingested WGP-DTAF by fluorescence-activated cell sorting (FACS). To monitor the uptake of orally administered WGP-DTAF, mice were fed 400 μg of the WGP-DTAF daily by intragastric administration and then examined on days 3, 7, and 12 for the presence of splenic, lymph node, and BM macrophages containing WGP-DTAF by FACS and fluorescence microscopy. Macrophages containing green WGP-DTAF were identified by red surface staining with the macrophage-specific antibody F4/80 coupled to the red fluorochrome, cychrome 5 (i.e., Cy5, BD Biosciences Pharmingen, San Diego, Calif.).

### EXAMPLE 1

Activation of the complement system and deposition of iC3b on injured tissues accompanies models of skeletal, smooth, and cardiac muscle ischemia/reperfusion injury is shown. Accumulating evidence suggests that such complement activation may represent an early signal of the need for tissue repair. Cleavage of C3 during complement activation yields i) solid phase iC3b that is deposited onto damaged tissues and ii) soluble anaphylatoxin C3a previously shown to sensitize chemotactic responses of C3aR⁺ hematopoietic stem progenitor cells (HSPC) to stromal derived factor (SDF-1). Recently it was observed that deposition of iC3b on bone marrow cells in models of radiation and cyclophosphamide-induced myelotoxicity. Since HSPC express the iC3b receptor, complement receptor 3 (CR3 or CD11b/CD18), it is hypothesized that iC3b generated during myelo-ablative treatrnent prior to hematopoietic transplants provides a tether that bind HSPC homing to bone marrow niches where HSPC subsequently differentiate and repopulate/regenerate the marrow. In mice deficient in CR3, reconstitution of blood leukocytes following myelo-ablative injury was significantly delayed compared to wild-type mice. Surprisingly, murine bone marrow CR3+Sca-1+c-kit+cells purified by FACS were enriched for mRNA specific for hepatocyte, neural, and skeletal muscle precursor cells. Thus, this is the first observation showing that cells expressing messages for non-hematopoietic e.g., hepatocyte, neural, and muscle progenitors are found among a population of bone marrow CR3+cells. In addition to HSPC, other tissue committed progenitor cells express CR3 and thus the iC3b-CR3 interaction plays an important role in regeneration of both hematopoietic and non-hematopoietic tissues.

### EXAMPLE 2

CR3/glucan receptor is present on a wide variety of committed stem cell progenitors and not just hematopoietic stem cells, and that glucan seems to have the ability to promote stem cell repair of many types of tissue injuries. For example, cardiac stem cells express CR3 and that cardiac tissue following a heart attack is a site of complement deposition and cardiac stem cell recruitment. The implication is that oral glucan therapy could enhance the repair of heart damage following a heart attack. CR3 has also been identified on neuronal stem cells and kidney stem cells While this invention has been particularly shown and described with references to preferred embodiments thereof, it will be understood by those skilled in the art that various changes in form and details may be made therein without departing from the scope of the invention encompassed by the appended claims.

What is claimed is:

1. A method of enhancing glucan-mediated committed stem cell proliferation and expansion after injury via the complement system pathway, comprising administering to an individual a therapeutically effective orally bioavailable amount of whole glucan particles, wherein the glucan activates and enhances committed stem cell proliferation via the complement system pathway.

2. The method of claim 1, wherein the orally administered whole glucan particles are taken up by macrophages, degraded and transported to the committed stem cells, wherein activation of the complement system pathway results from binding of glucan to iC3b deposited on a committed stem cell and proliferation results.

3. The method of claim 1, wherein the committed stem cells are selected from the group consisting of committed stem cells from the liver, heart, muscle, kidney and neural tissue.

4. A method of enhancing tissue repair via committed stem cell recruitment, comprising administering to an individual with an injury a bioavailable amount of whole glucan particles, wherein the glucan activates stem cell proliferation via the complement system pathway and enhances the stem cell recruitment to the site of injury.

5. A method of enhancing glucan-mediated committed progenitor stem cell recovery after injury via the complement system pathway, comprising administering to an individual a therapeutically effective orally bioavailable amount of whole glucan particles, wherein the glucan binds and activates the complement system pathway wherein committed progenitor stem cells are regenerated and proliferated.

6. The method of claim 5, wherein the orally administered whole glucan particle is taken up by macrophages, transported to the bone marrow, degraded and fragments released that prime the CR3 of stem cells activating the stem cells to differentiate and proliferate.

7. The method of claim 6, wherein the whole glucan particle via the complement system pathway promotes stem cell proliferation and differentiation by binding to iC3b deposited on injured stem cells and activating CR3.

8. A method of treating injury by delivering an agent and whole glucan particles to the site of injury and enhancing committed stem cell proliferation, comprising administering to an individual with an injury, an agent and whole glucan particles, wherein the whole glucan particles enhances glucan-mediated committed stem proliferation and the agent enhances injury recovery.
